(19) United States
(12) Patent Application Publication
(10) Pub. No.: US 2022/0235732 A1
(43) Pub. Date: Jul. 28, 2022

(54) ELONGATE WAVE ENERGY GENERATION DEVICES AND METHODS OF USING THE SAME

(71) Applicant: VitalNRG, Inc., San Diego, CA (US)

(72) Inventors: Kevin Barrett, San Diego, CA (US); Arthur Q. McNabb, San Diego, CA (US); Eldin Miller-Stead, San Diego, CA (US)

(21) Appl. No.: 17/611,863

(22) PCT Filed: May 18, 2020
(86) PCT No.: PCT/US20/33500

§ 371 Date: Nov. 16, 2021

Related U.S. Application Data
(60) Provisional application No. 62/849,074, filed on May 16, 2019.

(51) Int. Cl. F03B 13/20; F03B 13/10; F03B 13/22

(52) U.S. Cl. CPC F03B 13/20; F03B 13/22; F03B 13/10

(57) ABSTRACT

An elongate energy conversion device vertically oriented in a body of water with an oscillating core that converts wave movement into oscillating movement of a central housing, the housing including a set of ballscrews and threaded shafts which are then rotated and attached with generators to convert the rotational motion into electrical energy. The oscillating core is substantially enclosed by a movement resistant shell with a horizontally-extending heave plate which actuates the core depending on whether the oscillating core is being pulled upward from an attached float impacted by a wave crest or downward from an attached weight during a wave fall.

### BACKGROUND

### Field of the Invention

Devices and methods provided herein relate generally to devices that convert kinetic energy into electricity, and more particularly to an oscillating elongate device which converts the movement of ocean waves into purposeful movement that can be used to generate electricity, and various methods for their use.

### Related Art

In recent years, there has been a substantial influx in the ‘green energy’ market related to devices and methods for producing energy from fuel sources other than fossil fuels. The burning of fossil fuels has been the convention for providing both mechanical energy as well as electrical energy. In particular, many large-scale electric generators use the burning of fossil fuels to create and convert mechanical energy to electrical energy. The reliance on fossil fuels in both large and small-scale applications is driving a depletion of many conventional fossil fuel sources and may soon be unsustainable to meet our large energy demands. It is also a widely-held belief among scientists that the burning of these fossil fuels is adding to climate change. As a result, we believe that now is the time for innovation in energy production devices and methods which employ sustainable alternative fuel sources.

Conventional alternative energy devices known today include wind turbines, solar cells, geothermal and hydro-electric generators and others. These innovations have provided a huge step toward the long-term goal of cutting our reliance on fossil fuels, however, they have many drawbacks. These methods can be costly, both in monetary terms and in the energy consumption required to manufacture them. A wind turbine or solar farm typically costs millions of dollars to build, install, and maintain and are often deemed unsightly. In addition, the unpredictability of wind and weather can cause these units to go unused for quite some time. Hydro-electric plants rely on the proximity of a water source and the building of a dam which can be destructive to the local habitat.

Harvesting natural resources and developing sustainable energy sources that provide viable alternatives to fossil fuels calls for the creation of specialized devices. Therefore, it is desirable to develop devices which produce electricity without the limitations of fossil fuels and the inflexibility and unpredictability of current green energy sources.

### SUMMARY

Embodiments described herein provide for an elongate device vertically oriented in a wave-actuated body of water, the elongate device having an oscillating core slidably connected with a movement resistant shell, the oscillating core being further attached on a top end with a float on a surface of the body of water and attached on a bottom end with a weight, such that wave movement oscillates the core within the slidable connection with the movement-resistant shell to create a linear motion differential that is converted to rotational motion and finally electrical energy. The movement resistant shell may include a horizontally-extending heave plate radially extending from the shell to substantially resist the wave movement impacting the oscillating core, and the slidable connection with the oscillating core may be configured to impact an energy conversion device within the oscillating core and convert the linear motion differential into rotational motion and, using a generator disposed therein, electrical energy.

In one embodiment, An elongate energy conversion device comprises a core section with a central shaft movably disposed therethrough; at least one ballscrew disposed around a threaded shaft which is parallel to the central shaft, the ballscrew retained within a central housing such that it is in movable connection with the central shaft; a generator disposed on at least one end of the threaded shaft, wherein vertical movement of the central shaft and central housing creates rotational movement of the threaded shaft which is converted by the generator into electrical energy.

In another embodiment, a method of converting wave energy into electrical energy comprises the steps of: actuating a central shaft within a core section, the central shaft in movable connection with a central housing comprising at least one ballscrew disposed around a threaded shaft which is parallel to the central shaft; rotating the threaded shaft in response to the actuation of the central housing; and converting the rotation of the threaded shaft into electrical energy via a generator disposed on at least one end of the threaded shaft.

In another embodiment, the elongate device may be disposed horizontally within a body of water within a horizontal flow of current where the core is anchored to a fixed object on each end such that the current flow may instead cause an oscillating movement of the shell with respect to the core, thus still creating the movement of the fluid in the fluid-filled cylinders across the rotating wheel and conversion of the rotational movement into electrical energy.

Specifically, the elongate device provides the ability to capture and convert the unilateral bi-directional movement of waves into purposeful motion, such as rotational torque, which can then drive a generator shaft to produce electricity.

Described below are various embodiments relating to methods of use of the device; however, many additional applications and uses are possible. Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts and in which:

FIG. 1 is a side cut-out view illustration of an elongate wave energy conversion device in a first position, according to an embodiment of the invention;

FIG. 2 is a side cut-out view illustration of the elongate wave energy conversion device in a second position, according to an embodiment of the invention;

FIG. 3 is a side cut-out view illustration of an elongate wave energy conversion device with a solid shaft, according to an embodiment of the invention;

FIG. 4 is a side cut-out view illustration of an energy conversion system mounted within the wave energy conversion device, according to one embodiment of the invention;

FIG. 5 is a side cut-out view illustration of an elongate wave energy conversion device with a flexible membrane covering the fluid-filled cylinders, according to an embodiment of the invention;

FIG. 6 is a series of front and side-view illustrations of a core of the elongate wave energy conversion device, according to one embodiment of the invention;

FIG. 7 is a side cut-out view illustration of an elongate wave energy conversion device in a horizontal configuration, according to one embodiment of the invention;

FIG. 8 illustrates an exemplary method of converting bi-directional movement of the elongate wave energy conversion device into electrical energy, according to one embodiment of the invention;

FIG. 9 is a front cut-out view illustration of an alternate design of an elongate wave oscillation device, according to one embodiment of the invention;

FIG. 10 illustrates a side cut-out view illustration of the alternate design of the elongate wave oscillation device, according to one embodiment of the invention;

FIGS. 11A-11C illustrate various cut-out views of a core section of the alternate design of the elongate wave oscillation device, according to one embodiment of the invention;

FIG. 12 illustrates a front cut-out view illustration of the alternate design of the elongate wave oscillation device with a second plunger, according to one embodiment of the invention;

FIG. 13 is a close-up side view illustration of the core section of the design of the elongate wave oscillation device with the first and second plungers, according to one embodiment of the invention;

FIG. 14 is a side-view illustration of the core section with generator covers disposed on outer portions of the core section, according to one embodiment of the invention;

FIG. 15 is a conceptual illustration of the alternate design of the elongate wave oscillation device mounted to a fixed vertical object in a wave-actuated body of water, according to one embodiment of the invention;

FIG. 16 is a conceptual illustration of the alternate design of the elongate wave oscillation device mounted to a floor of a wave-actuated body of water, according to one embodiment of the invention;

FIG. 17 is a conceptual illustration of the alternate design of the elongate wave oscillation device in electrical connection with a nearby device, according to one embodiment of the invention;

FIG. 18 is a side perspective view illustration of an elongate wave energy conversion device with a turbine-driven energy conversion device, according to one embodiment of the invention;

FIG. 19 is a side perspective view illustration of the elongate wave energy conversion device with dampening springs positioned on either side of the turbine-driven energy conversion device, according to one embodiment of the invention;

FIG. 20 is a bottom perspective view illustration of the elongate wave energy conversion device illustrating a configuration of rotors, stators and guide vanes which make up the turbine-driven energy conversion device;

FIG. 21A is a side perspective view illustration of a Wells turbine as would be utilized in the turbine-driven energy conversion device, according to one embodiment of the invention;

FIG. 21B is a side perspective view illustration of an impulse turbine with a set of guide vanes positioned on either side of a unidirectional rotor as would be utilized in the turbine-driven energy conversion device, according to one embodiment of the invention;

FIG. 22 is a side perspective view illustration of a ball screw design of the elongate wave oscillation device, according to one embodiment of the invention;

FIG. 23 is a side perspective view illustration of a fluid-filled generator compartment and fluid-filled core compartment of the ball screw design of the elongate wave oscillation device, according to one embodiment of the invention;

FIG. 24 is a side perspective view illustration of a central housing in the fluid-filled core compartment of the ball screw design of the elongate wave oscillation device, according to one embodiment of the invention;

FIG. 25 is a side view illustration of the central housing in the fluid-filled core compartment of the ball screw design of the elongate wave oscillation device, according to one embodiment of the invention;

FIG. 26 is a side perspective view illustration of the fluid-filled generator compartment, according to one embodiment of the invention;

FIG. 27 is a side perspective view illustration of a cover of the central housing, according to one embodiment of the invention;

FIG. 28 is a top perspective view illustration of a central connector of the central housing, according to one embodiment of the invention;

FIG. 29 is a side view illustration of a moveable heave plate, according to one embodiment of the invention;

FIG. 30A-C are side view illustrations of the movable heave plate in different movable positions, according to one embodiment of the invention;

FIG. 31 is a side view illustration of a foldable heave plate in a folded configuration, according to one embodiment of the invention; and

FIG. 32 is a top-down view illustration of the foldable heave plate in an unfolded configuration, according to one embodiment of the invention.

### DETAILED DESCRIPTION

Certain embodiments described herein provide for an elongate device vertically oriented in a wave-actuated body of water with an oscillating core slidably connected with a movement resistant shell, the oscillating core being further attached on a top end with a float on a surface or subsurface of the body of water and attached on a bottom end with a weight, such that wave movement slidably oscillates the core within the movement-resistant shell to create a linear motion differential that is converted to rotational motion via an energy conversion device and into electrical energy via a generator. The movement resistant shell may include a horizontally-extending heave plate radially extending from the shell to substantially resist the wave movement impacting the oscillating core, and the shell may include actuating arms disposed on opposite ends of the oscillating core to impact an energy conversion device during oscillation of the oscillating core to convert the linear motion into rotational motion which, using a generator disposed therein, is then converted into electrical energy.

In one embodiment, the energy conversion device may be a set of fluid-filled cylinders disposed on either end of a central chamber with a rotating wheel, where actuating arms attached with the movement resistant shell compress and simultaneously decompress the fluid-filled cylinders during oscillation of the core to push and pull fluid across the rotating wheel, generating rotational motion that can then be converted into electrical energy by the generator. The fluid within the cylinders enters the central chamber and passes over the rotating wheel using a set of one-way valves adjacent to each fluid-filled cylinder to cause unidirectional rotation of the rotating wheel regardless of the direction of oscillation of the core.

The elongate device may function at any depth and can be placed at any depth simply by adjusting a length of a cable connecting the float to the oscillating core. Additionally, the elongate device may be formed in a cylindrical, rectangular or other elongate shape so long as the shape allows for a movement differential between the shell and the oscillating core.

The embodiments of this device include, but are in no way limited to, the following applications illustrated in the various figures herein, which correspond to potential locations and environments for the device based on varying types of extrinsic bodies and forces which can act upon the device.

Additionally, the embodiments described herein are designed to be scalable to various sizes depending on their specific application or desired power generation. For example, a large device may be placed in a body of water to translate the movement of the body of water into a significant amount of power for industrial or commercial uses, while a portable device may be designed which simply scales down the design of the device for placing on an anchor line, buoy or anchored horizontally in a waterway.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

### I. Vertically-Oriented Elongate Wave Oscillation Device

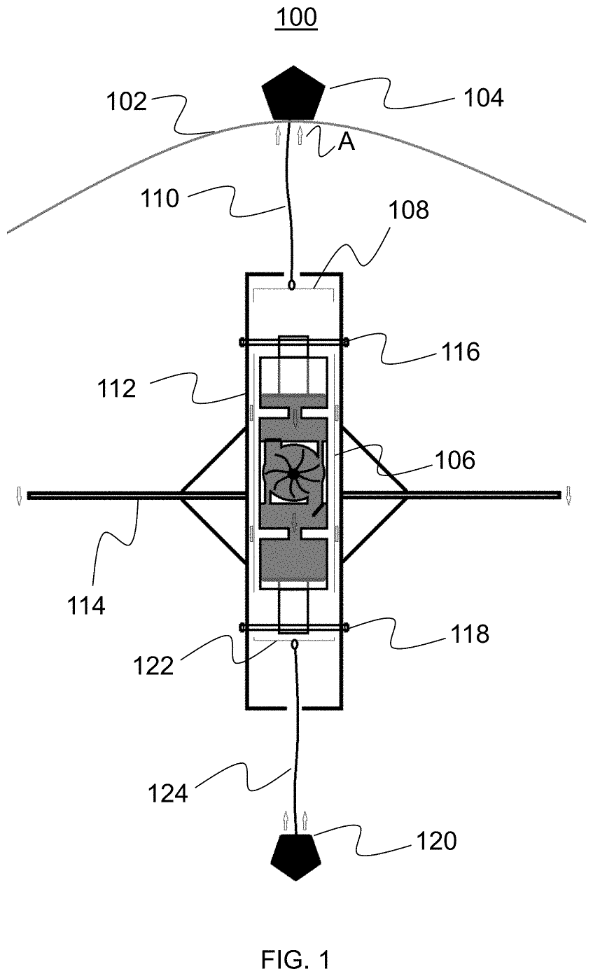

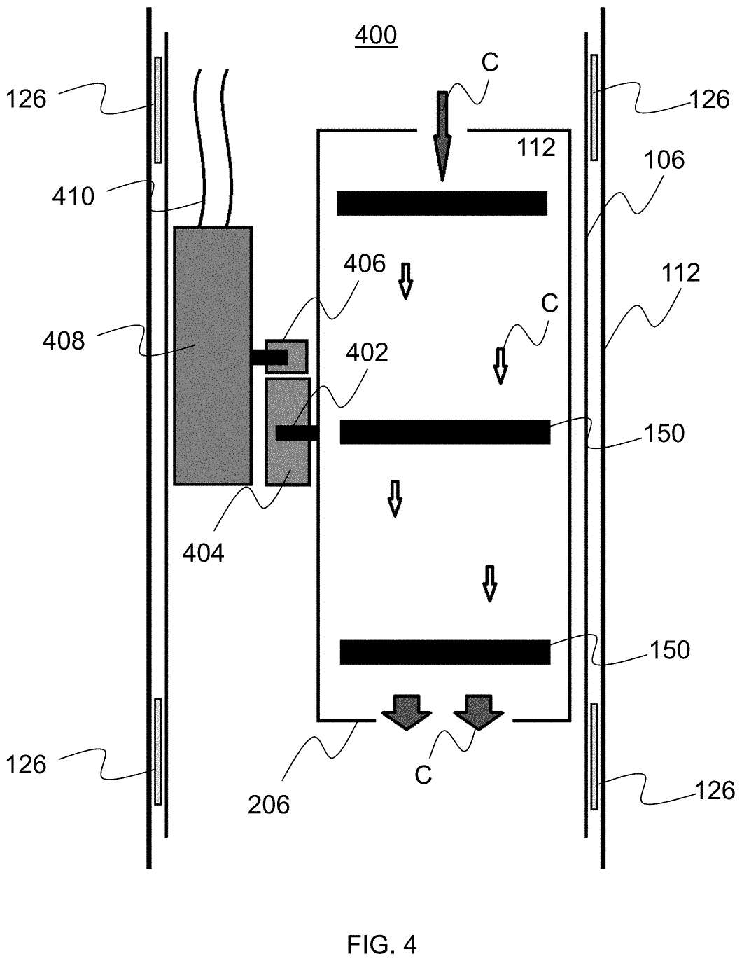

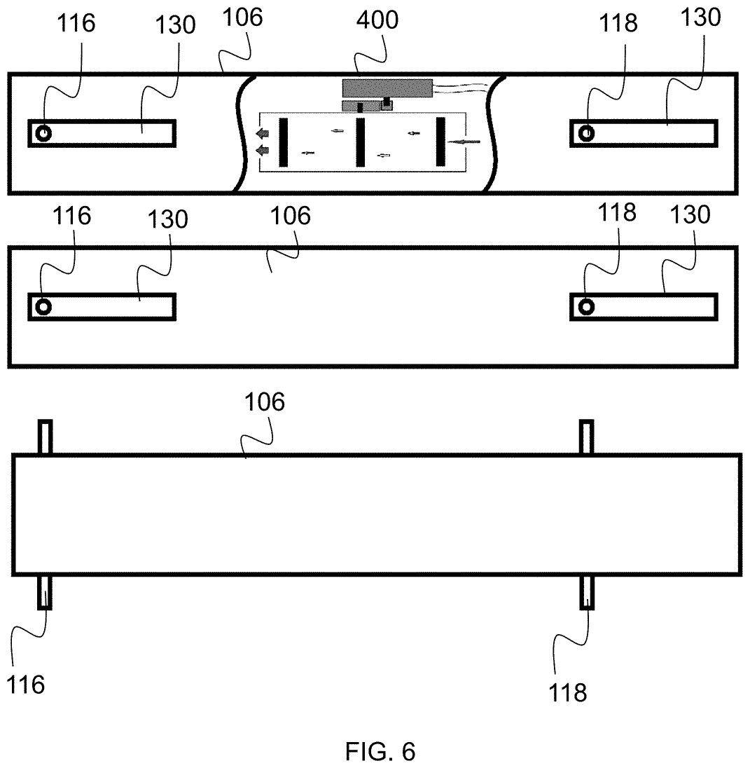

FIG. 1 is a side cut-out view illustration of one embodiment of an elongate wave oscillation device 100 in a first position where a wave crest 102 has actuated a float 104 upward. The wave oscillation device 100 includes a core section 106 which is attached with the float 104 at a first end 108 via an upper cable 110 such that the vertical, upward movement of the float (shown by directional arrows A) translates into vertical, upward movement of the core section 106. The core section 106 is at least partially surrounded by a movement resistant shell 112 which is configured with a resistance device 114 designed to prevent the shell from moving with the oscillating core 106. In this embodiment, the resistance device 114 is a heave plate which extends radially outward from the shell 112 to create resistance when a vertical force is applied to the heave plate 114 in either direction. The shell 112 is slidably attached with the core 106 via an upper drive arm 116 and lower drive arm 118 which are disposed across the diameter of the shell 112 and bisect openings in the core 106 (see FIG. 6). While the core 106 is pulled upward via the float 104, the shell 112 is inclined to remain stationary due to the force required to pull up the heave plate 114, thus creating the differential in movement between the core 106 and the shell 112. Similarly, a weight 120 may be attached to a second end 122 of the core 106 via a lower cable 124 to pull the core 106 downward when a wave crest 102 has passed by, creating a further linear motion differential between the core 106 and shell 112. The differential in movement is then utilized with the upper drive arm 116 and lower drive arm 118 to impact an energy conversion device such as that described below to convert the oscillating movement of the core 106 into rotational movement, which can then be easily converted into electrical energy via a generator (see FIG. 4).

The float 104 may be disposed on top of a surface or slightly below the surface if needed, so that the float does not protrude out of the water. The length of the cable 110 may vary and allow the device 100 to operate at any depth.

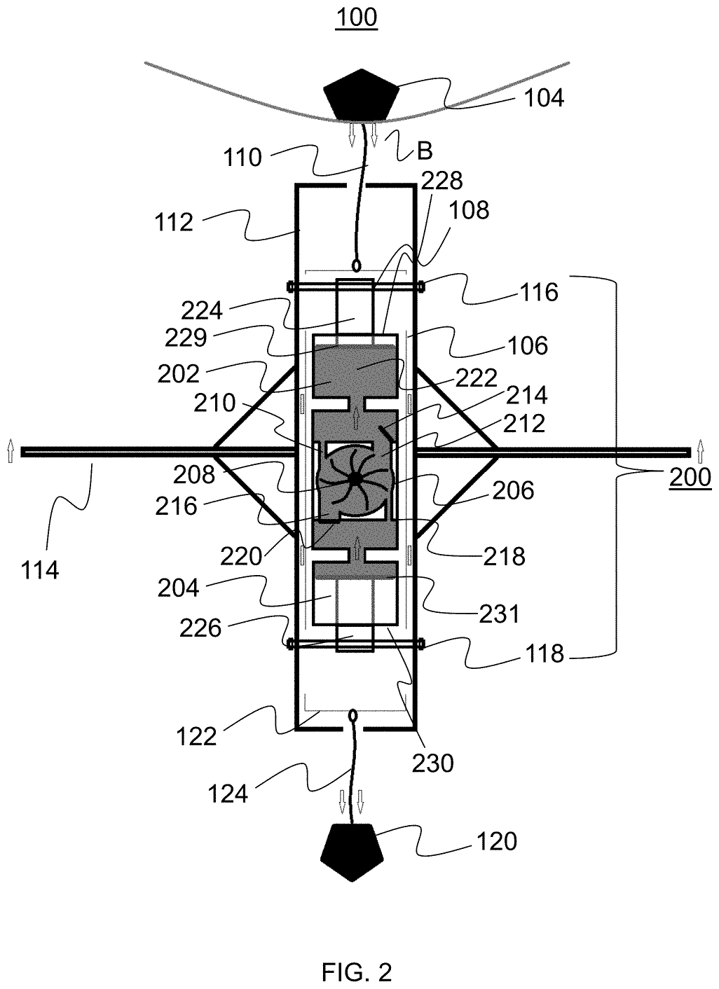

FIG. 2 illustrates a side cut-out view illustration of the elongate wave oscillation device 100 in a second position where a wave crest 102 (see FIG. 1) has passed by, and the float 104 is now lower than in the first position. In this second position, the weight 120 attached with the second end 122 of the core section 106 via the lower cable 124 will act to pull the core section 106 downward and actuate the core section 106 in an opposing direction (shown by direction arrows B) of its upward movement in FIG. 1, thus creating a linear, back and forth oscillating movement of the core section 106 from the first position in FIG. 1 to the second position in FIG. 2 as waves crest and fall.

In one embodiment, the core section 106 includes an energy conversion device 200 which translates the oscillating movement of the core section 106 into rotational movement via the movement differential between the core section 106 and the movement resistant shell 112. In the embodiment illustrated herein, the energy conversion device 200 is enclosed primarily within the core section 106 and includes a first fluid-filled cylinder 202 and second fluid-filled cylinders 204 disposed on either side of a central chamber 206 containing a rotating wheel 208 such as a Pelton wheel. The first cylinder 202 is in fluid connection with the central chamber 206 via two orifices on opposite sides of the first cylinder 202 from one another. A first orifice 210 on a left side of the first cylinder 202 may be fully open between the first cylinder 202 and the central chamber 206, while a second orifice 212 on a right side of the first cylinder 202 may be configured with a one-way valve 214 to prevent fluid from passing from the right side of the first cylinder 202 into the central chamber 206. Thus, the one-way valve 214 of the second orifice 212 closes when fluid is pushed from the first cylinder 202 into the central chamber 206 in order to force fluid through the first orifice 210, as the first orifice 210 is positioned to allow the fluid to impact blades of the rotating wheel 208 to cause the wheel 208 to rotate in a singular (in this case counter-clockwise) direction.

Similarly, first and second orifices 216 and 218 of the second fluid-filled cylinder 204 on the opposing side of the central chamber 206 have an opposite configuration of the first cylinder 202, as the second cylinder 204 is configured with a one-way valve 220 over the first orifice 216 on the left side of the second cylinder 204 immediately opposite the first orifice 210 in the first fluid-filled cylinder 202. This configuration prevents fluid from entering the central chamber 206 in an opposing direction of the fluid flow from the first orifice 210 of the first fluid-filled cylinder 202, as it would otherwise force the rotating wheel 208 to spin in a clockwise direction. Fluid in the second fluid-filled cylinder 204 therefore passes through the second orifice 218 (without a one-way valve) on the right side of the second cylinder 204 and into the central chamber 206 on the opposing side of the rotating wheel 208 from the first orifice 216, where it will impact the blades of the rotating wheel 208 to further rotate the rotating wheel 208 in the same counter-clockwise direction as the fluid entering the central chamber 206 from the first orifice 210 in the first fluid-filled cylinder 202.

Therefore, regardless of whether the fluid is being pushed into the central chamber from the first cylinder 202 or second cylinder 204, the fluid will always act upon the rotating wheel 208 to rotate the wheel in the same direction while preventing fluid from acting upon the rotating wheel 208 in an opposite direction. In another embodiment, one-way valves may also be added to the first orifice 210 and the second orifice 218 to prevent even nominal backflow through these passages and ensure that the rotating wheel 208 moves as efficiently as possible.

Fluid 222 in the fluid-filled cylinders are actuated into the central chamber 206 by upper and lower actuating arms 224 and 226 movably positioned over end portions 228 and 230 of each of the respective fluid-filled cylinders 202 and 204, and include sealed plungers formed 229 and 231 within the circumference of the fluid-filled cylinders 202 and 204 to actuate the fluid 222 into or out of the cylinders in a vacuum-sealed environment. The upper actuating arm 224 is attached with the upper drive arm 116 that is anchored to the outer shell 112, while the lower actuating arm 226 is attached with the lower drive arm 118.

As shown in FIG. 1, while the core section 106 oscillates upward from the upward movement of the float 104 in response to the wave crest movement 102, the shell 112 resists this movement due to the resistance of the heave plate 114 and instead uses its relative stability to cause the upper actuating arm 224 to push the fluid 222 in the first fluid-filled cylinder 202 toward the central chamber 206, while the lower actuating arm 226 actuates in the same direction as the upper actuating arm 224, thereby simultaneously pulling the fluid 222 out of the central chamber 206 and into the second cylinder 204.

In the opposing motion of the core section 106 shown in FIG. 2 via directional arrows B, while the core section 106 oscillates downward from the downward movement of the weight 120 due to gravity and the passing of the wave crest 102, the shell 112 again resists this downward movement due to the resistance of the heave plate 114 and uses its relative stability to cause the lower actuating arm 226 to push the fluid 222 in the second fluid-filled cylinder 204 toward the central chamber 206, while the upper actuating arm 224 actuates in the same direction as the lower actuating arm 226, thereby simultaneously pulling the fluid 222 out of the central chamber 206 and into the first cylinder 202.

It is important to note that by actuating both fluid-filled cylinders to simultaneously both push fluid into the central chamber and pull fluid out of the central chamber on the opposing side of the central chamber, the rotating wheel is also both pushed and pulled in the same direction. Thus, the device embodied herein may overcome the limitations of Betz's law regarding the maximum power that can be extracted from the flow of air or fluid over a turbine blade. Another principle of the elongate device is that with this embodiment, the lifting force which lifts the oscillating core via the float is two times greater than the lowering force of the weight (combined with gravity). The result of this principle is that when the core oscillates vertically, half of the lifting force is used to generate electricity, while the other half of the lifting force is used to increase the potential energy; conversely, when the oscillating core moves downward, all of the lowering is used to generate electricity.

The outer shell may partially, substantially or entirely surround the core section depending on the particular application and environment, although its primary function is to act as a resistance device to actuate the fluid within the fluid-filled cylinders of the core section. Furthermore, the size of the heave plate may be customized depending on the overall size of the elongate device as well as the desired electrical generation power of the elongate device, as a larger heave plate will create more resistance and thus a greater movement differential between the oscillating core. However, the heave plate may also be designed with a moderate size which only provides resistance up to a certain amount of wave energy in order to effectively limit the upper range of electrical generation and protect the elongate device from excessive wave forces (such as large waves during a storm) that might otherwise create enough of a movement differential to overstress the components of the device and cause a failure.

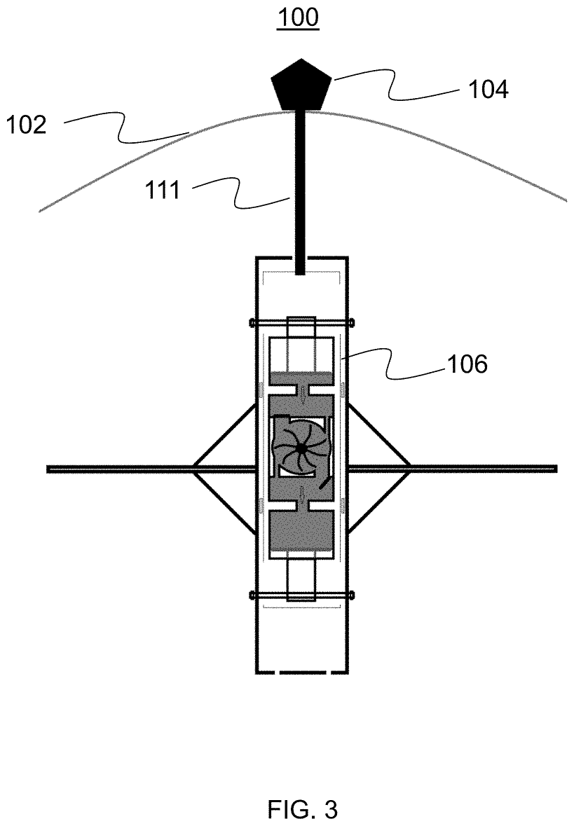

In an alternate embodiment, FIG. 3 shows a side cut-out view illustration of an elongate oscillation device 100 with a rigid shaft 111 connecting the core section 106 with the float 104. The solid shaft 111 acts similarly to the upper cable 110 to pull the core section 106 upward in direction A via the float 104, but unlike the upper cable 110, the solid shaft 111 is also capable of pushing the core section 106 downward in the opposing direction B as the float 104 drops after a wave crest 102. This may eliminate the need for the weight 120 disposed on the second end 122 of the core section 106 (as shown in FIG. 2) since the rigid shaft 110, using the weight of the float and gravity, would push down onto the core section 106 when a wave crest 102 has subsided, while still pulling up on the core section 106 when a wave crest 102 impacts the float 104 upward. Additionally, in another embodiment, the core section could be weighted on its own so that the weight of the core section causes actuation of the core section in a downward direction via gravity after a wave crest, similarly eliminating the need for the weight 120.

FIG. 4 is a side-view cut-out illustration of an electrical generation system 400 mounted within the core section 106 of the wave energy conversion device, showing blades 150 of the rotating wheel 208 (see FIG. 2) being impacted by the directional arrow movement C of the fluid through the central chamber 206. A drive shaft 402 is connected with a central shaft (not shown) of the rotating wheel 208 and actuates a series of differential gears 404 and 406 that are then connected with a flywheel and/or generator 408 to convert the rotational movement into electrical energy. The electrical energy may then be transmitted out of the device 100 via electrical wires 410 which may be disposed within the upper cable 110 or run separately to an external device which requires the electrical power. In this embodiment, the generator 408 is disposed within the core section 106, although in alternate embodiments (not shown), the generator may be disposed outside of the core section or even the outer shell 112. In another embodiment, the generator may also be a linear generator.

This embodiment in FIG. 4 also illustrates the use of slides 126 disposed between the core section 106 and the outer shell 112 to allow for the slidable connection between the core section 106 and outer shell 112 to be as consistent and as linear as possible during oscillating movement of the core section 106 within the outer shell 112.

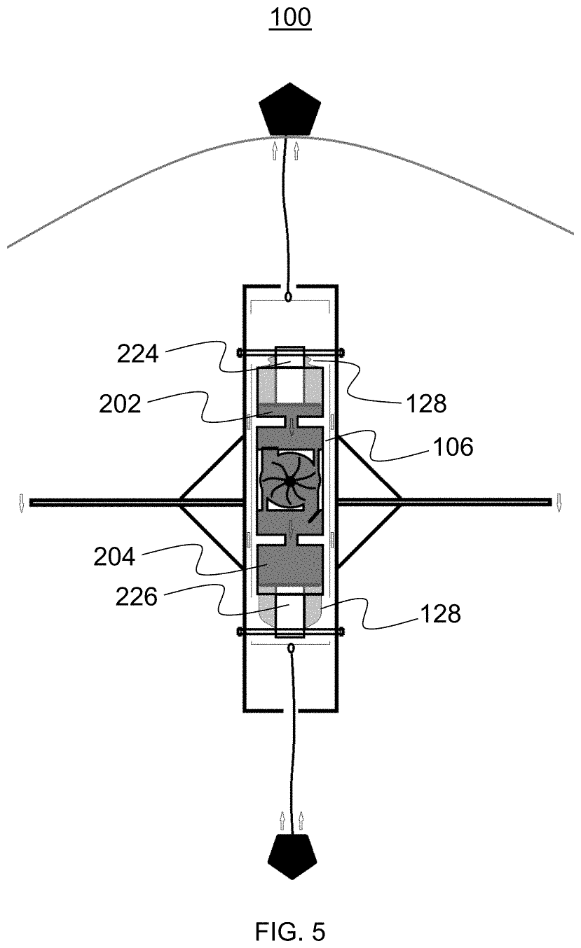

FIG. 5 is a side cut-out view illustration of the elongate wave energy conversion device 100 with a flexible membrane 128 covering the fluid-filled cylinders where the actuating arms 224 and 226 impact into and out of the cylinder bodies 202 and 204. By covering this area with the flexible membrane 128, it creates a sealed environment where the actuating arms impact into the cylinder bodies, thus preventing any external fluid or contaminants from getting into the seal between the actuating arms and circumferential edges of the cylinder bodies. As shown in FIG. 5, when the upper actuating arm 224 is fully impacted into the first fluid-filled cylinder 202, the membrane 128 may be in a relaxed, unflexed state. In contrast, on the opposing end of the core section 106 where the lower actuating arm 226 is substantially removed from the second fluid-filled cylinder 204, the flexible membrane 128 is in a fully stretched, flexed state.

FIG. 6 is a series of side-view and top-view illustrations of the core 106 of the elongate wave energy conversion device separate from the outer shell in order to illustrate the outer structure of the core 106 and the slidable connection between the core 106 and the outer shell 112. In the top two illustrations, a side view of the core 106 is shown with slider openings 130 where the upper drive arm 116 and lower drive arm 118 from the shell penetrate through the core section. In the top illustration, a cut-away view of the electrical generation system 400 is shown for scale. The bottom illustration is a top-view of the core section 106, showing the penetration of the upper drive arm 116 and lower drive arm 118 through both sides of the core section 106. Thus, this figure more clearly illustrates how the core section moves separately from the outer shell 112 and how the drive arms 116 and 118 anchored with the outer shell 112 slide along the core section 106 within the slider openings 130 during the oscillating movement of the core 106.

### II. Horizontally-Oriented Elongate Wave Energy Conversion Device

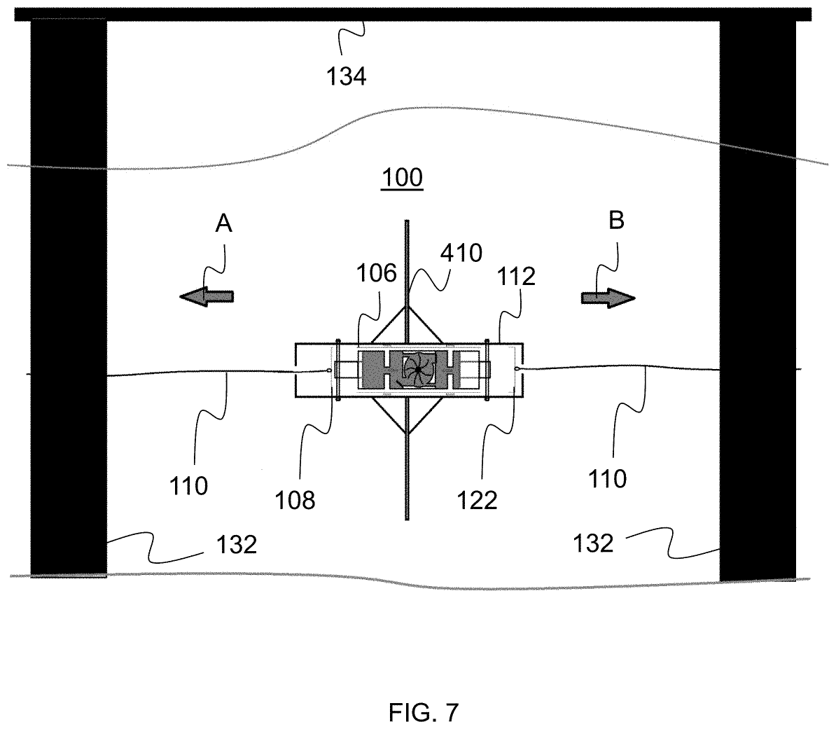

Although the previously-described embodiment is configured for use in a vertical orientation in a wave-actuated body of water, the device may be positioned horizontally in a body of water with horizontal movement. FIG. 7 is a side cut-out view illustration of an elongate wave energy conversion device 100 in a horizontal configuration, where the first end 108 and the second end 122 of the core section 106 are both attached via cables 110 with an anchor 132, such as a pier support column below a pier 134. This allows the horizontal flow of a body of water in either direction (represented by arrow A and arrow B) to actuate the outer shell 112 in the primary direction of horizontal flow while the core section 106 remains stationary due to the tension in the cables 110. If the body of water has a natural oscillation (such as an ocean surge), the shell 112 will oscillate with respect to the now stationary core 106 to create the movement differential needed for activation of the energy conversion device. However, if the body of water primarily flows in only one direction, the device may be mounted directly behind the anchoring device 132 in order to benefit from the oscillations formed behind by the anchoring device 132 described as the Von Karmen Vortex flow movement.

### III. Applications

The elongate device may function at any depth and can be placed at any depth simply by adjusting a length of a cable connecting the float to the oscillating core. From a practical standpoint, it may be attached to any device in the ocean which needs electricity, such as a navigational, weather or sensor buoy. The elongate device may be connected directly to a buoy or other floating object that will act as the float to cause oscillation of the core while also utilizing the connecting cable to transmit generated electricity to the buoy or floating object that may require power.

Additionally, the device may be separately connected with a device requiring power through a separate transmission cable, and the device may be located adjacent to a stationary, anchored object near the shore that needs power. The size of the elongate device may vary depending on the application and the required power for the application, but the device itself is scalable up or down. In one embodiment, the device may be portable, with modular parts which can be easily disassembled and moved from one location to another

### IV. Methods of Use

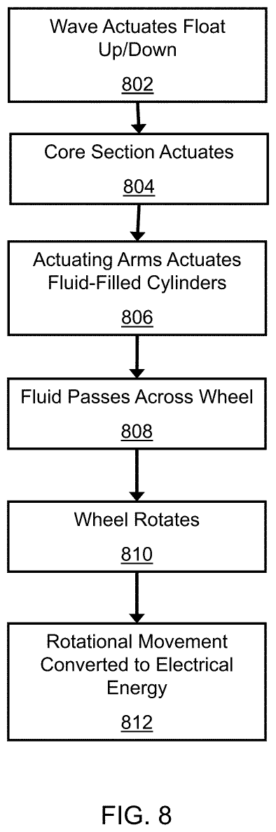

FIG. 8 illustrates an exemplary method of using the elongate energy conversion device to generate electrical energy. In a first step 802, a wave crest moves a float connected with the device up or down, which, in step 804, moves a core section of the device in a corresponding up or downward direction. In step 806, the actuation of the core section causes the actuating arms connected with the movement resistant outer shell to actuate the fluid-filled cylinders, by pushing fluid within a fluid-filled cylinder on the first end of the core section into a central chamber while simultaneously pulling fluid from the central chamber into the fluid-filled chamber on the second end of the core section. In step 808, the fluid moves in a single direction through the central chamber causing, in step 810, rotation of the rotating wheel in a single direction. In step 812, the rotational movement is converted into electrical energy using a generator disposed within the device.

### V. Alternate Design

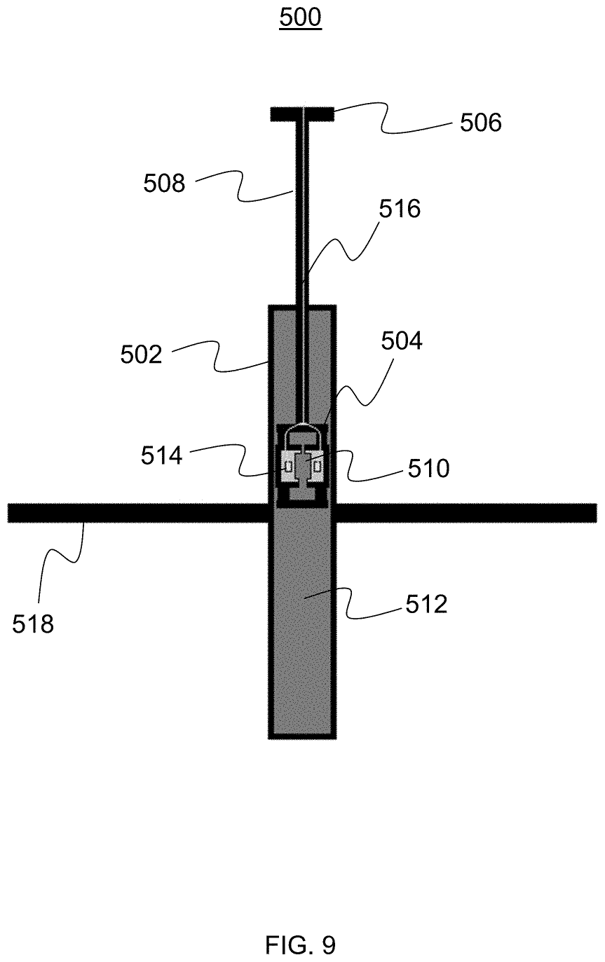

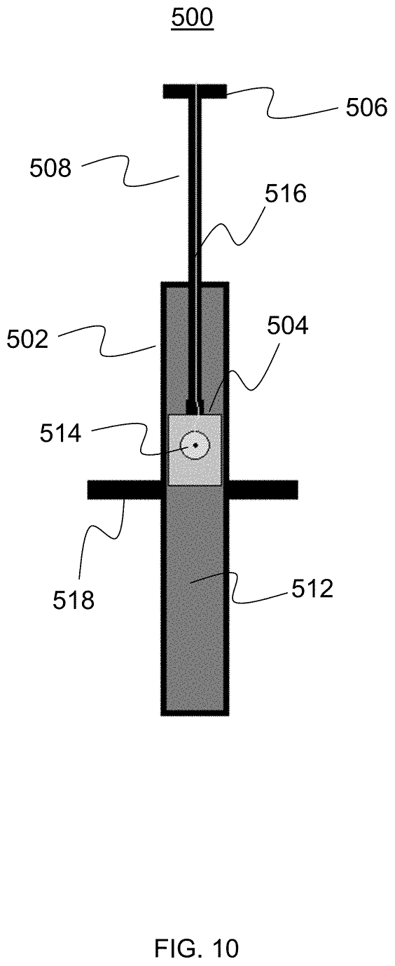

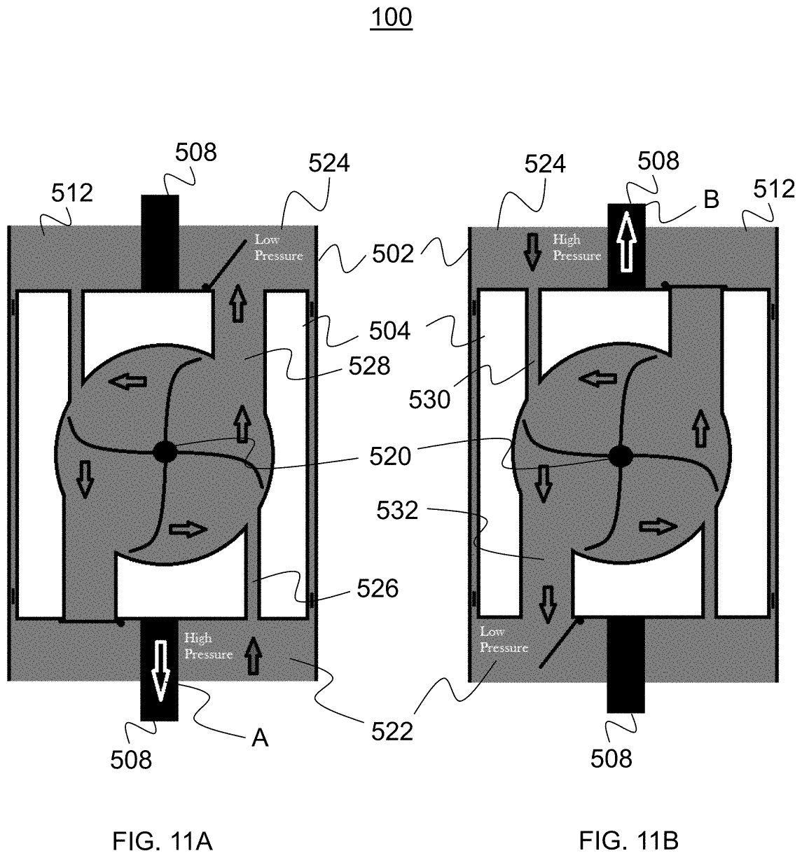

FIG. 9 is a front cut-out view illustration of an alternate design of an elongate wave oscillation device 500, with a fluid-filled shell 502 encasing a core section 504 that is actuated within the shell 502 via a plunger 506 attached to the core section 504 via a rigid shaft 508. The core section 504 includes a wheel chamber 510 with a wheel (see FIG. 11A) which turns in response to the movement of fluid 512 through the core section 504 as the core section oscillates within the shell 502. The rotational movement of the wheel is then converted into electrical energy via adjacent generators 514, and the resulting electrical energy may be transferred to an adjacent device via a wire 516 running through the shaft 508. A heave plate 518 which extends radially outward from the shell 504 aids in creating resistance when a vertical force is applied to the heave plate 518 in either direction, aiding in the oscillation of the plunger 506 and core section 502 within the shell 502. FIG. 10 illustrates a side cut-out view illustration of the alternate design of the elongate wave oscillation device, illustrating the position of one of the generators 514 disposed within the core section 504 and in electrical connection with the wire 516 running through the shaft 508.

FIGS. 11A-11C illustrate various cut-out views of a core section 504 of the alternate design of the elongate wave oscillation device 500, illustrating the movement of fluid 512 the wheel chamber 510 to rotate a wheel 520. The fluid moves in response to the movement of the shaft 508 in a downward direction (Arrow A in FIG. 11A) or upward direction (Arrow B in FIG. 11B), creating high pressure in one portion of the fluid-filled shell on one side of the core section 504 and low pressure in an opposing portion of the fluid-filled shell 502 on the other side of the core section 504, as will be described in further detail below.

In FIG. 11A, when the shaft 508 moves downward (Arrow A), it creates a higher pressure in a lower portion 522 of the fluid-filled shell 502 below the core section 504 while simultaneously creating a lower pressure in an upper portion 524 of the fluid-filled shell 502. The pressure differentials force the fluid 512 through a small diameter lower orifice 526 and into the wheel chamber 510, turning the wheel 520 in a counter-clockwise direction and allowing the fluid to exit the wheel chamber 510 into the upper portion 524 through a large diameter upper orifice 528.

FIG. 11B illustrates the opposite situation where the shaft 508 moves upward (Arrow B), creating a higher pressure in the upper portion 524 of the fluid-filled shell 502 above the core section 504 while simultaneously creating a lower pressure in the lower portion 522 of the fluid-filled shell 502. The pressure differentials force the fluid 512 through a small diameter upper orifice 530 and into the wheel chamber 510, turning the wheel 520 in a counter-clockwise direction and allowing the fluid to exit the wheel chamber 510 into the lower portion 522 through a large diameter lower orifice 532. As has been described in the previous embodiments, a series of one-way valves are positioned across the large diameter orifices to prevent fluid from back flowing

FIG. 11C is a side-view cut-out illustration of the core section 504 more clearly illustrating the position of one of the generators 514 which may be disposed on either side of the wheel chamber 510, additionally showing the location of the wire 516 which transmits the generated energy to an external device (not shown) via the shaft 508. The core section 504 is also more clearly illustrated as a substantially enclosed device with the large diameter openings (528 and 532) on either side governed by one-way valves.

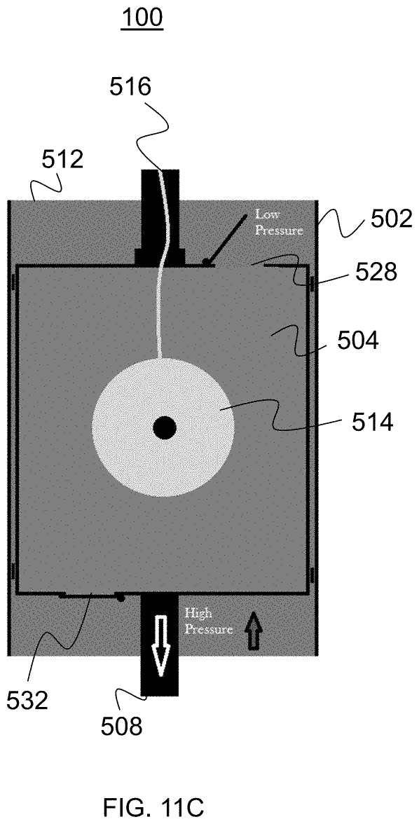

FIG. 12 illustrates a front cut-out view illustration of the alternate design of the elongate wave oscillation device with a second plunger 534 and shaft 536 connected on a lower end of the device 500.

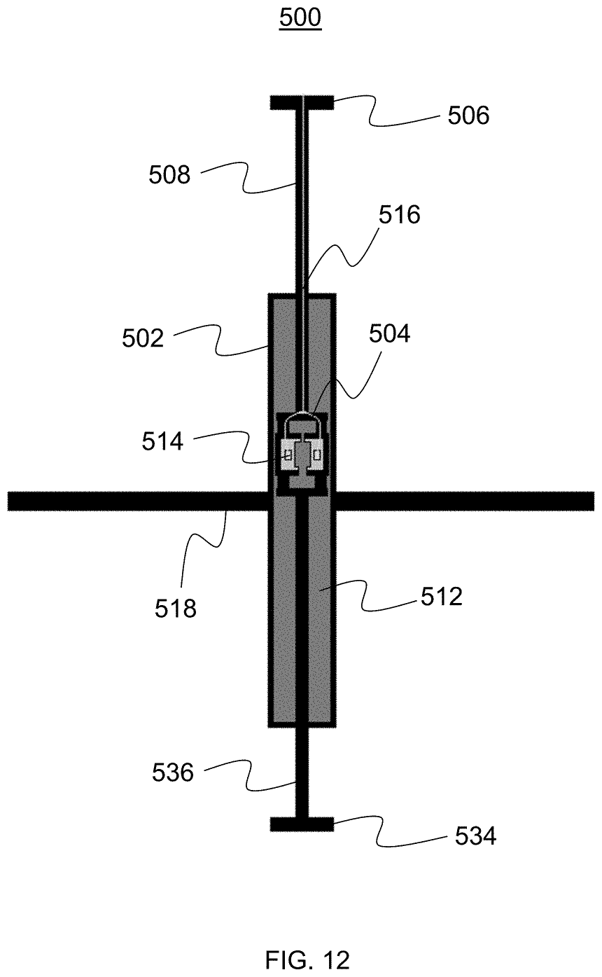

FIG. 13 is a close-up side view illustration of the core section 504 of the design of the elongate wave oscillation device with the first and second plungers, illustrating how the wheel 520 is rotatably connected with the generators 514 via rotating drive shafts 538. The rotating shafts 538 then rotate the components of the generators 514 to convert the rotational energy into electrical energy, which may then be transmitted through the wires 516 to an electrical device.

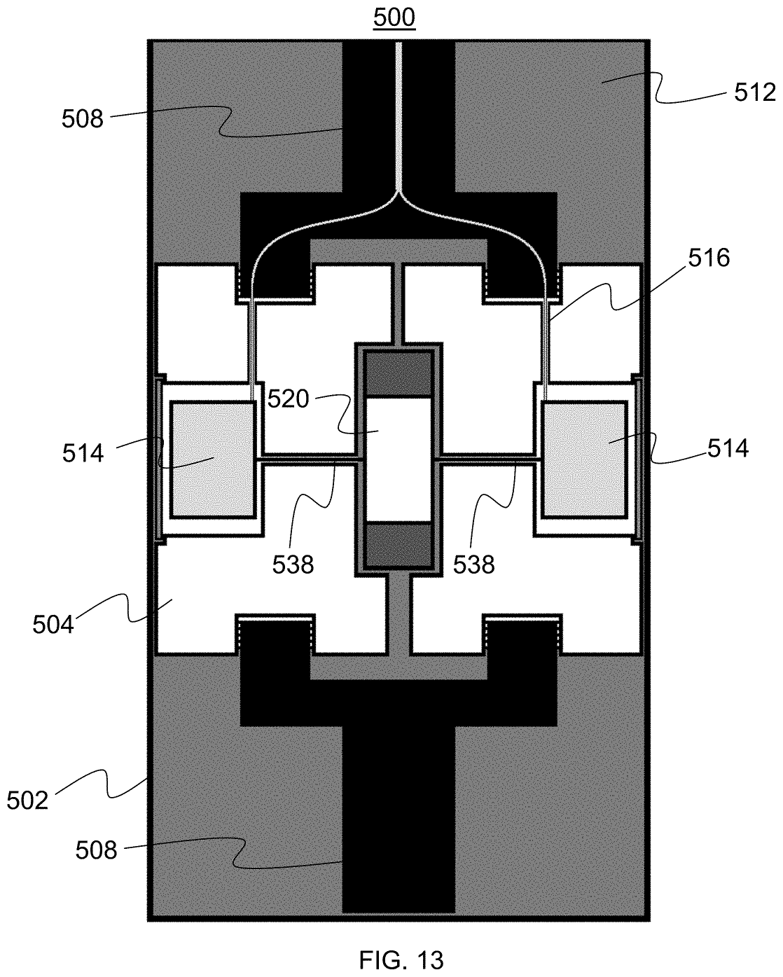

FIG. 14 is a side-view illustration of the core section 504 illustrating the connection between the wheel chamber 510 and adjacent generator chambers 540 housing the generators. In order to access the generators for maintenance and assembly, removable generator covers 542 may be disposed on outer portions of the core section 504.

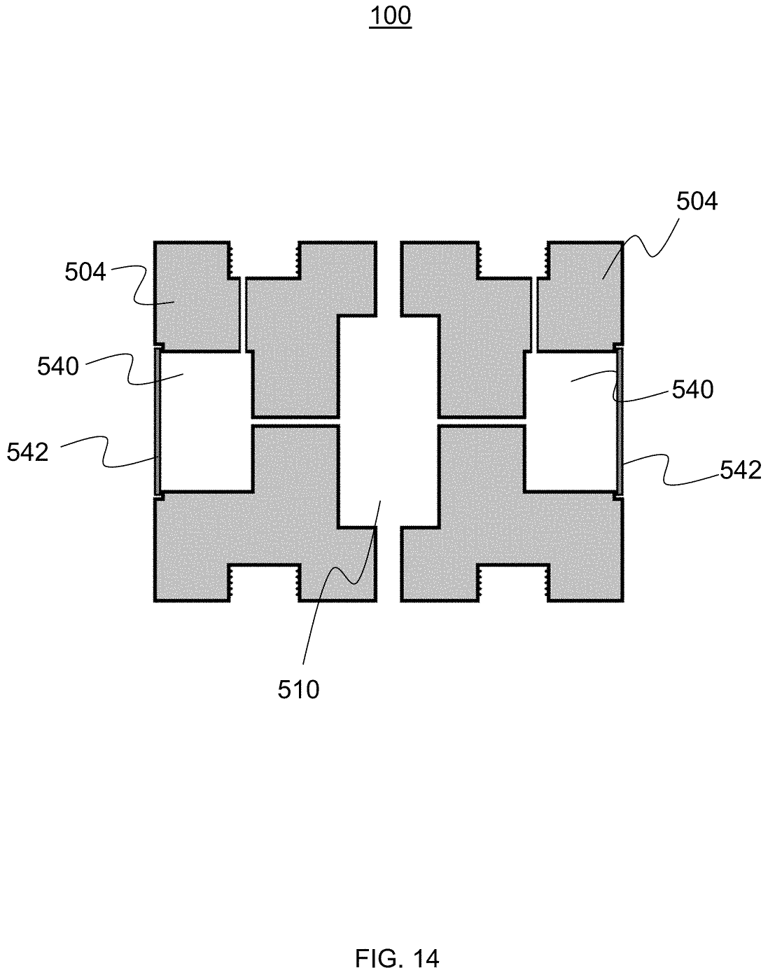

FIG. 15 is a conceptual illustration of the alternate design of the elongate wave oscillation device 500 mounted to a fixed vertical object in a wave-actuated body of water 512, such as a pier 546. The device 500 may be mounted to a support piling 544 via one or more mounting beams 548. As the surface of the wave-actuated body of water 512 moves up and down, a float 506 such as a buoy acts as the plunger to actuate the shaft 508 upward and downward, causing the core section 504 to oscillate within the shell 502.

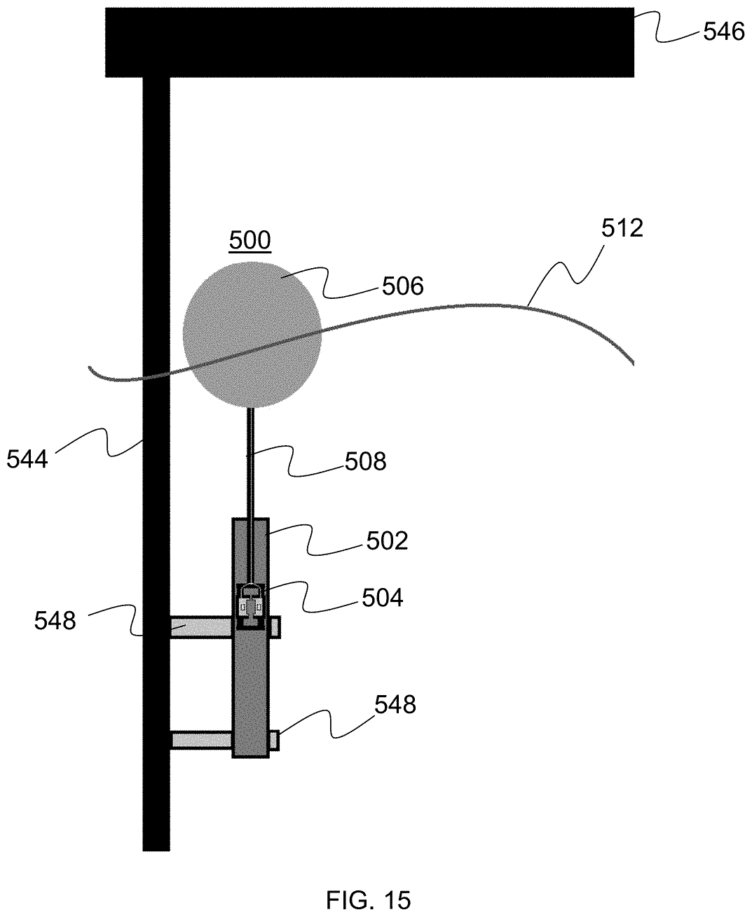

FIG. 16 is a conceptual illustration of the alternate design of the elongate wave oscillation device 500 mounted to a floor 550 of a wave-actuated body of water, according to one embodiment of the invention. In this embodiment, the shell 502 is substantially enclosed by an anchor 552 which maintains the device on the floor 550 of the body of water. Furthermore, since the shell 502 is fixed with the floor 550, a float 506 such as a buoy floating on the surface of the water 512 is attached via a flexible cable 554 to a weighted actuating arm 556 which acts to pull the buoy 506 in a downward position to oscillate the core section 504 within the shell 502. When the surface of the water rises, the buoy pulls the weighted actuating arm 556 upward via the flexible cable 554, thus oscillating the core section 504 in the opposing direction.

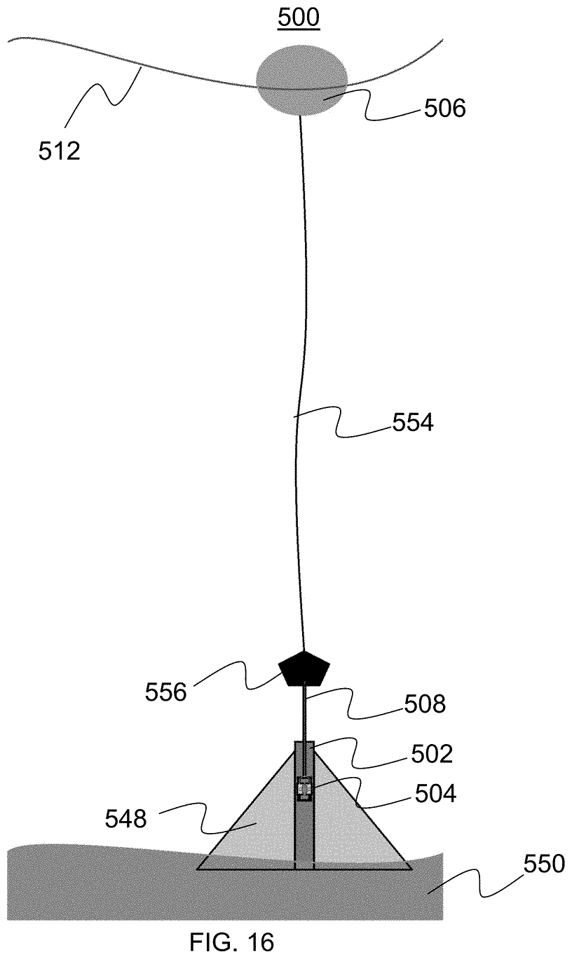

FIG. 17 is a conceptual illustration of the alternate design of the elongate wave oscillation device 500 with a lower mounted weight 558 in electrical connection with a nearby electrical device 560 in the body of water via a wire 562. The nearby electrical device 560 which is separately anchored by a weight 564, according to one embodiment of the invention. This configuration allows the elongate wave oscillation device 500 to power a nearby object to which it is not directly connected with on the surface

In one embodiment, the entire oscillating device 500 may be further encased in an outer shell which encapsulates the shell, shaft and plunger in order to protect all of the devices from objects which may affect the functionality of the device. The outer shell may have a series of openings to allow water from the surrounding body of water to enter and move the plunger up and down to actuate the device.

### VI. Turbine-Driven Core Section

In one embodiment, a double acting hydraulic cylinder converts linear motion to rotation of a turbine-driven generator within the cylinder. The linear motion can be generated from any source (car, train, truck, machine, human, animal, ocean, wind, river, etc.). The device can convert slow (such as ocean) or fast (such as machine vibration) reversal of motion.

As one example of its potential application, the included illustrations demonstrate how the device is placed in the ocean, where the cylinder has an oscillating core that is substantially enclosed by a movement resistant shell with a horizontally extending heave plate. The linear motion which is created by a buoy lifting a mass (increasing the potential energy of that mass) while simultaneously driving the core (turbine rotor, stator, generator, gear and cone) through the fluid filled cylinder to generate a pressure drop across a turbine which will thereby rotate and in turn thereby spin a generator while the buoy is rising up to a wave crest. When the buoy drops from the wave crest to the wave trough the mass under force of gravity will convert its potential energy into kinetic energy of turbine rotation by again driving the core (now in the opposite direction) through the fluid filled cylinder designed to maximize the pressure drop across a turbine which will spin a generator. The generator within the cylinder may be driven by a turbine that can rotate in either direction or be designed to rotate in only one direction no matter the direction of the linear force.

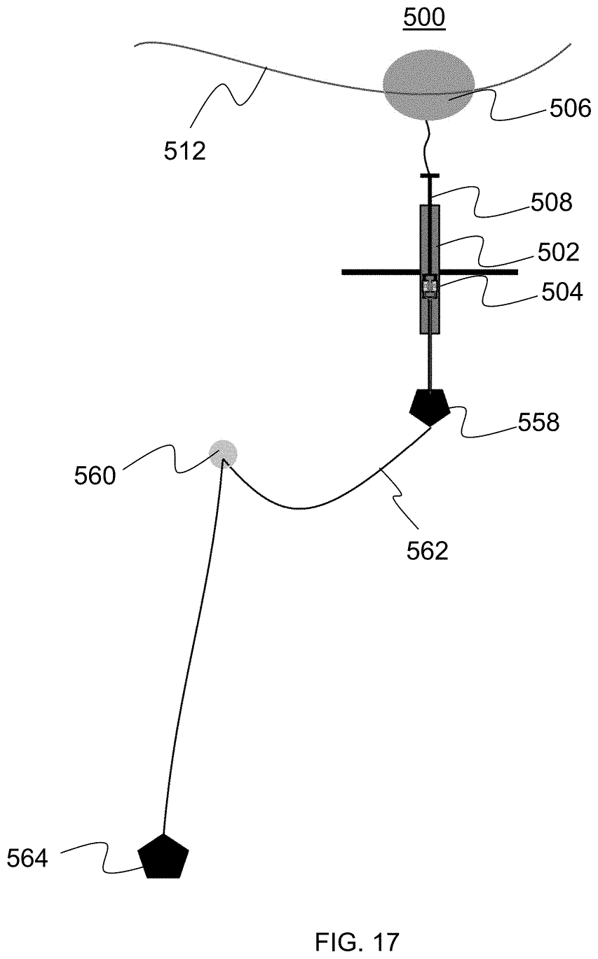

As illustrated in FIGS. 18-21, the energy conversion device may have a central core with a horizontally-oriented turbine which is rotated by the fluid movement from the first cylinder to the second cylinder (and vice-versa). The rotating turbine is then connected with a generator as described below to convert the rotational energy of the turbine into electrical energy.

FIG. 18 is a side perspective view illustration of the elongate wave energy conversion device illustrating the turbine-driven energy conversion device movably disposed within the center of the core section. The turbine and generator are positioned together in the middle of the core section and capable of slidably moving up and down the core section similar to the previous embodiments. The core section may be connected on either end to a rigid shaft attached to a float and weight, respectively, which along with the heave plate cause the wave energy conversion device to oscillate in response to external wave energy. The oscillation then pushes the fluid within the core section across the turbine due to the pressure drop on one side of the turbine and the pressure increase on the other side of the turbine. The turbine design allows significant fluid flow across the blades which then increases the velocity of the rotating turbine and thus increases the amount of rotational energy available for conversion into electrical energy. Additionally, since the fluid-filled core section is completely sealed from the external environment, there is no danger of contaminants or other objects impacting the turbine and impeding the fluid flow or rotation of the turbine.

As is also illustrated in FIG. 18, in one embodiment, a cone-shaped covering may be disposed around the upper and lower central shaft, immediately adjacent the turbine to direct fluid to the outer circumference of the turbine where it will then directly impact the turbine blades, further increasing the velocity of fluid flow across the blades.

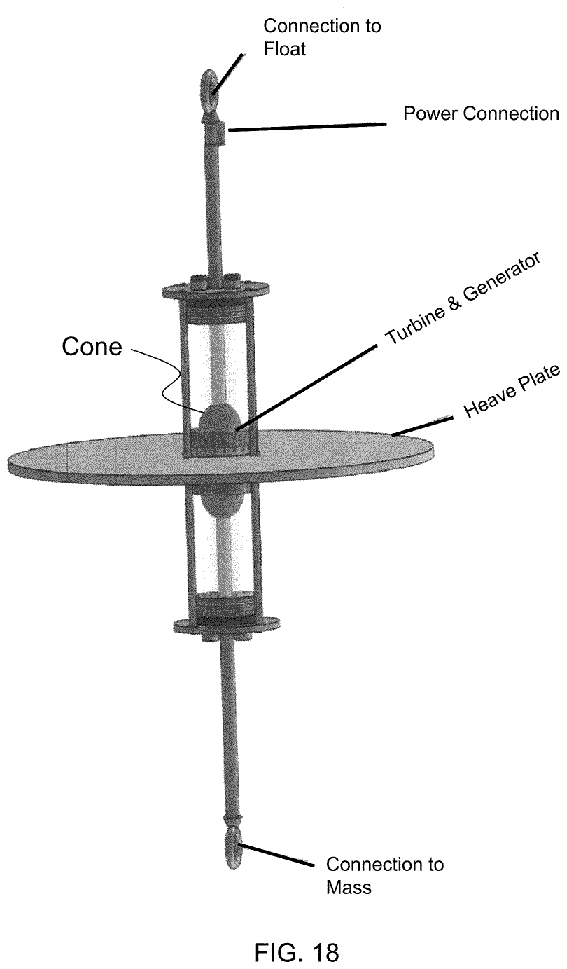

FIG. 19 is a side perspective view illustration of the elongate wave energy conversion device with dampening springs positioned on either side of the turbine within the core section in order to act as a dampener (and collector of energy to use when the linear motion reverses) to the movement of the turbine during the oscillation of the wave energy conversion device. The springs may be generally disposed around the central shaft and extend from the smaller upper point of the cone-shaped covering to an upper and lower end of the core section.

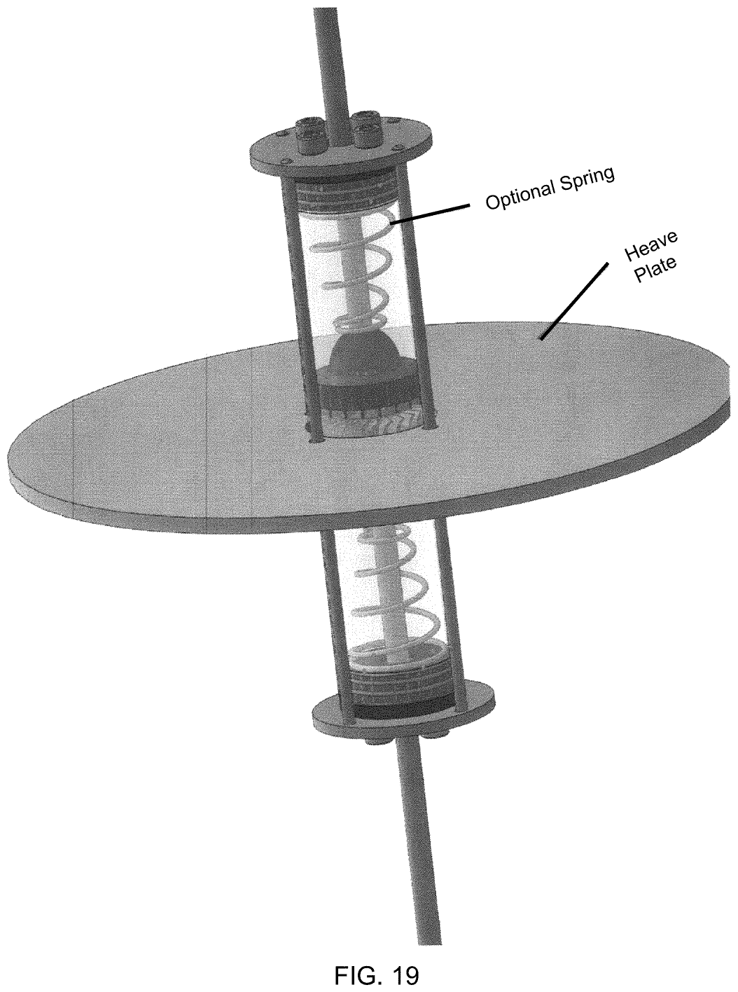

FIG. 20 is a bottom perspective view illustration of the elongate wave energy conversion device which more clearly illustrates the design and placement of the turbine and generator within the core section. Here, the turbine is surrounded by stators positioned above and below, the stators having a plurality of fixed guide vanes to guide the fluid from either side of the core section into an angle which more directly impacts the rotor blades, as will be more specifically described and illustrated below. The stator is positioned on either side of the rotor. Additionally, this embodiment demonstrates an alternate embodiment of the outer cylinder and exterior support shafts disposed between the two end caps of the core section. In this embodiment, an O-ring may be disposed around the interior portion of the end cap which interfaces with the core section in order to maintain the sealed, liquid-filled environment.

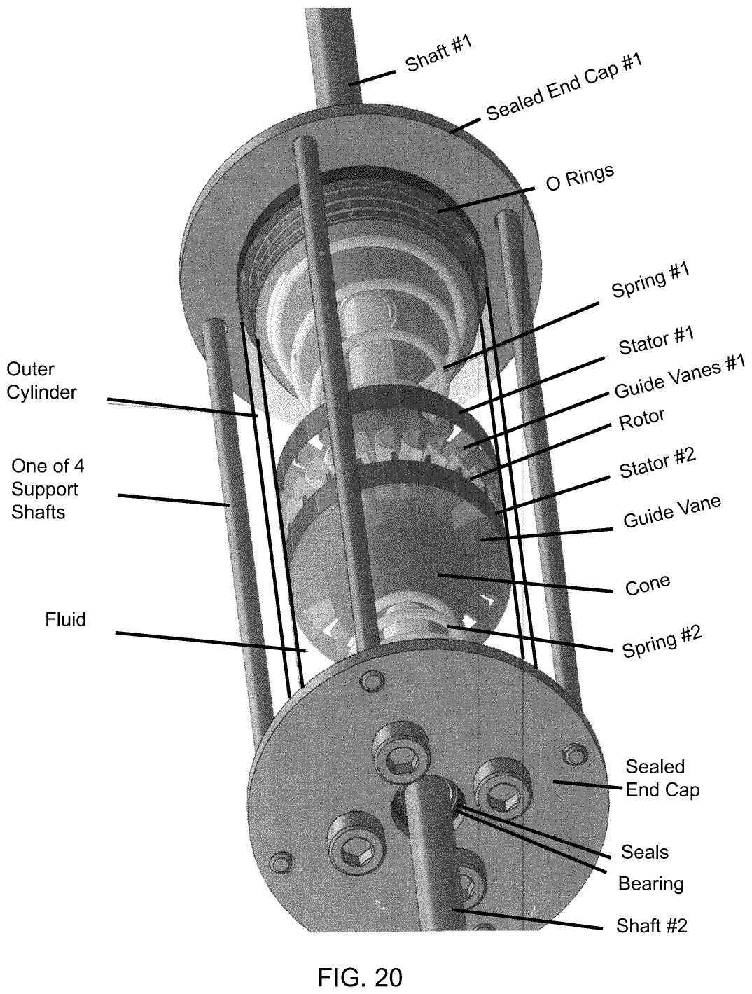

FIG. 21A is a side perspective view illustration of a Wells turbine that may be utilized as the turbine in the turbine-driven core section. A Wells turbine has blades which are uniquely shaped to rotate in a singular direction regardless of the direction of air (or liquid) flowing across the blades. Thus, the Wells turbine will continue to rotate in the same direction as the fluid flows from one side of the core section to another, creating a continuous rotational movement that can be converted into continuously-generated electrical energy.

FIG. 21B is a side perspective view illustration of an impulse turbine as previously illustrated in FIG. 20, including a set of guide vanes positioned on either side of a unidirectional rotor. As initially described above, the rotor blades may be shaped with a concave and convex angle to allow for rotation in a single direction upon impact of fluid from either side of the guide vanes across the pressure drop. The guide vanes are also positioned at an angle to push fluid toward the rotor blades at that angle in order to maximize the force being applied to the rotor blades.

The center portion of either turbine contains the generator with a separate stator and rotor which convert the rotational movement of the turbine into electrical energy. As shown in FIG. 18, a power connection may be positioned on a top portion of the device such that the electrical energy generated by the generator is transmitted through the central shaft via a wire to the power connection.

### VII. Ball Screw Shaft Configuration

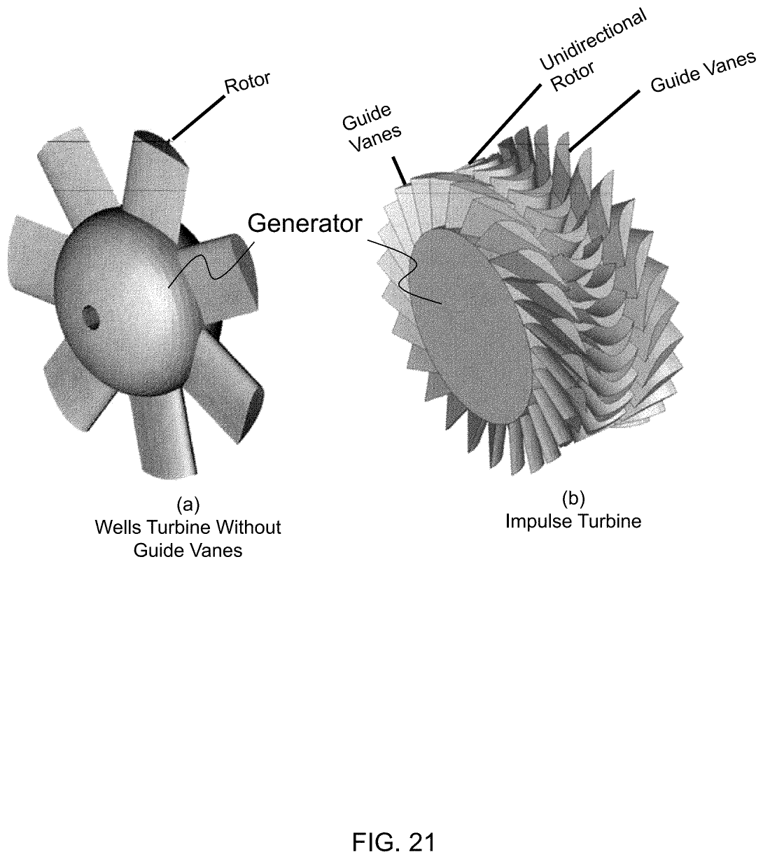

In one embodiment illustrated in FIG. 22, an elongate wave energy conversion device 900 incorporates a fluid-filled central core 902 with a central housing 904 comprising a set of ballscrews 906, such that linear movement of the central housing 904 about a central shaft 908 is translated into rotational movement of ballscrew shafts 910. Generators 912 are then disposed in a fluid-filled generator compartment 914 on at least one end of each of the ballscrew shafts 910 in order to convert the rotational motion into electric potential, as has already been described above with regard to the previous embodiments.

As with the prior embodiments, the vertical movement of the central core 902 about a central shaft 908 drives the overall device movement. Eye bolts 916 may be positioned at one or more ends of the central shaft 908 for attaching to a float (at the top) or weight (at the bottom) to actuate the central shaft in response to external movement from a wave. As the device 900 experiences a force applied to the central shaft 908 (such as an upward force from a buoy or downward force from a weight), the opposing reactionary force will be applied to the central core 902 through one or more heave plates (not pictured) that attach to the core 902 at attachment plate 918 disposed on each end of the central core 902, causing the central housing 904 to move from one end of the central core 902 to another, thereby spinning the ballscrew shafts 910.

Note the generator compartment 914 and the central core 902 may be fluid filled and sealed from the external environment where the central shaft enters the core 902 via an upper seal 920 and lower seal 922. The generator compartment 914 and central core 902 can share fluid or be sealed from each other via a separate seal positioned between the two sections. This allows the device to have little to no detrimental effects when being placed in a body of water to any depth or in any fluid or non-fluid environment. It allows for control of the fluid or air around the core and generator components to minimize degradation.

The device is scalable both in size and number of shafts/generators in each device, and could be used in or on land, air or water in or alongside most any machine. It can be pulled, pushed or both by anything that moves with reciprocating motion. This device, like all these devices, could be configured with the central shaft 908 terminating at the top (or bottom) with some connection to the prime mover and the other end terminating at the central core 902 of the device. It is preferable to have the central core 902 pulled and pushed from the same end.

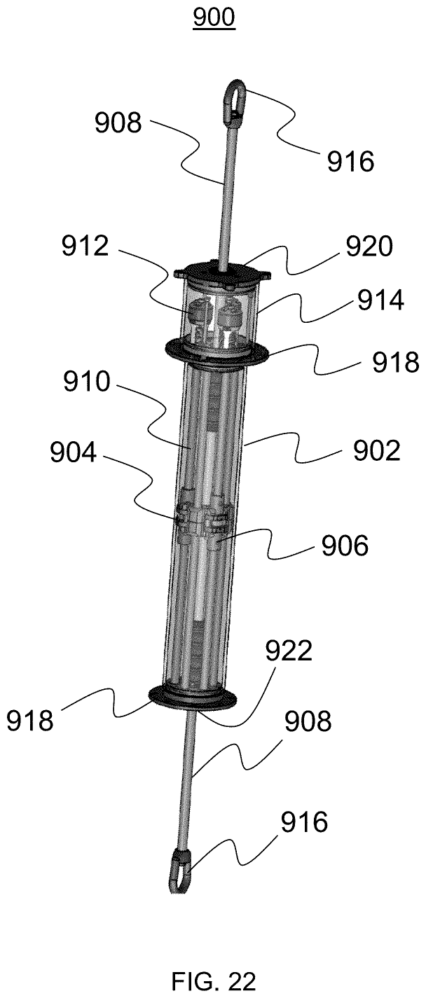

FIG. 23 is a closeup illustration of the fluid-filled generator compartment 914 and fluid-filled core compartment 902 of the ball screw design of the elongate wave oscillation device, which more clearly illustrates the configuration and design of the central housing 904 and ball screws 906 within the central core 902. In this embodiment, the central housing 904 is designed with a plurality of ballscrews 906 disposed in a circular configuration around the central core 902, where each ballscrew 906 is disposed around a ballscrew shaft 910. In this particular embodiment, a ballscrew 906 is disposed on an upper and lower portion of the central housing 904 such that each ballscrew shaft 910 includes two ballscrews 906.

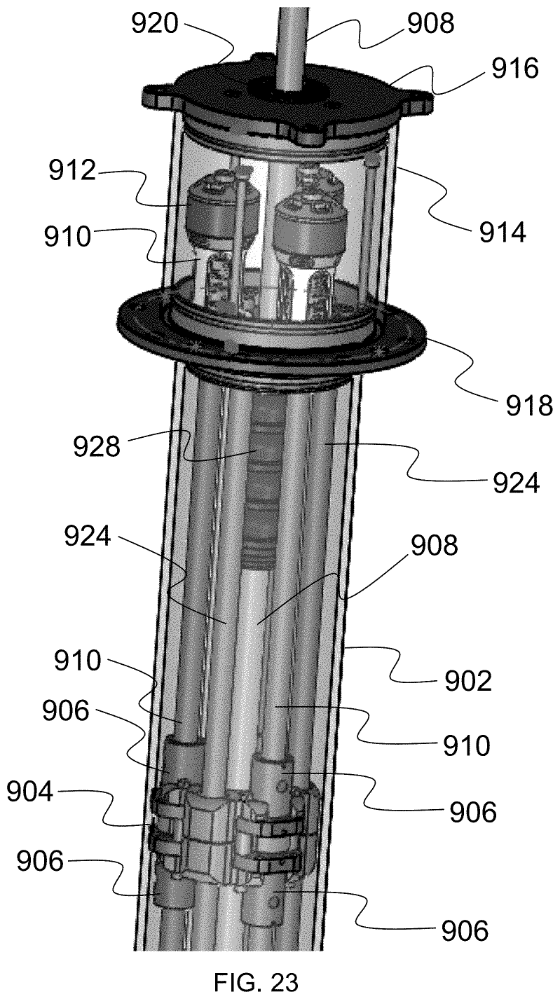

Additionally, as shown by the detail view of the central housing 904 in FIG. 24, this embodiment also includes a plurality of linear guide shafts 924 that are designed to keep the entire structure straight and secure, with corresponding guide shaft supports 926 in the central housing 904. The central housing 904 is made up several parts; in this embodiment there are 3 sets of 2 ballscrews 906 (6 total) and the top and bottom central housing cover 904, although the number may vary depending on the size and scale of the overall device. Also shown in this illustration are rubber bumpers 928 at each end and bearings at the end of the ballscrew shafts which buffer the movement of the central core 904 as it moves from one side of the central chamber 902 to another.

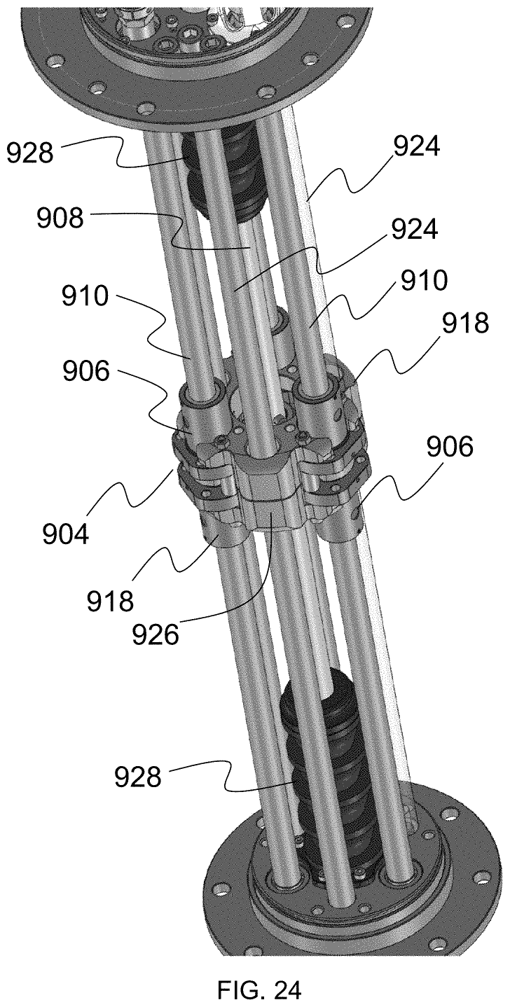

FIG. 25 is a cut-away illustration of the central housing 904 to more clearly illustrate a linear bearings chamber 930 which comprises the primary component of the ballscrew 906, along with a central connector 932 which movably connects the central shaft 908 with the ballscrews 906 on the central housing 904. It also shows 1 of 2 pins 934 that connect the main shaft to this central core.

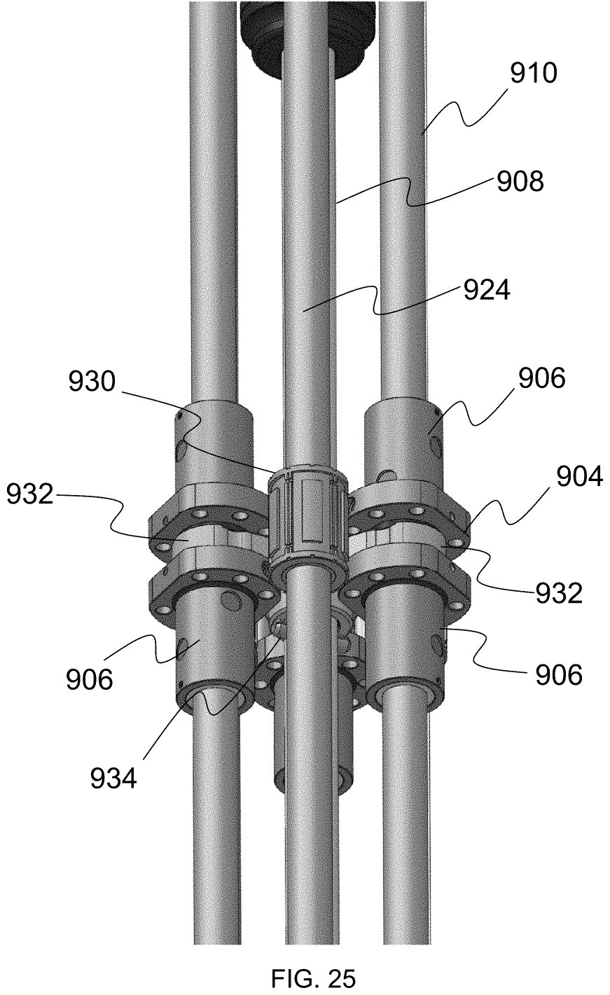

FIG. 26 is a side perspective cutaway view illustration of the fluid-filled generator compartment 914, according to one embodiment of the invention. The generator compartment includes the central shaft 908 passing through the middle of 3 generators 912. Each generator may also include a generator mount 936 and coupling 938 of each to the ballscrew shafts 910.

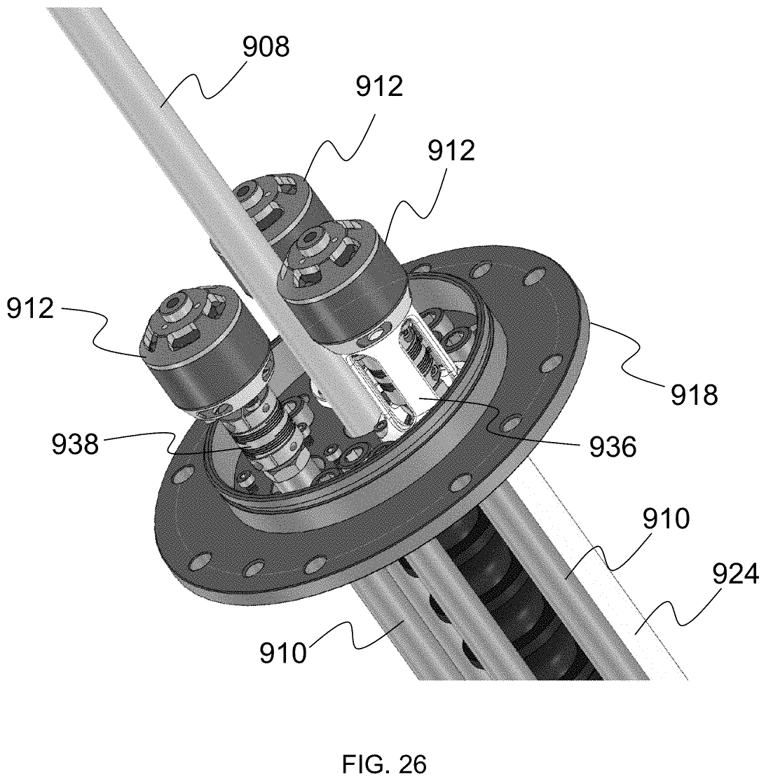

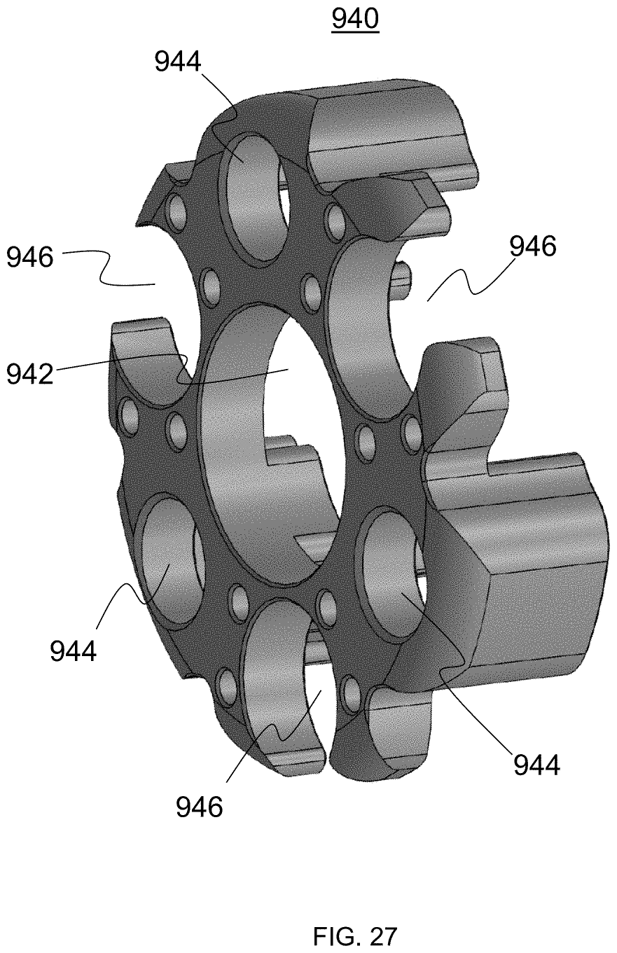

FIG. 27 is a side perspective view illustration of a cover portion 940 of the central housing, according to one embodiment of the invention, showing the overall structure of the central housing and the position and location of a central shaft through hole 942, ballscrew shaft through holes 944, and linear guide shaft through holes 946. Similarly, FIG. 28 is a top perspective view illustration of the central connector 932 of the central housing, illustrating the overall structure of the part which movably connects the central shaft with the ballscrews via their respective contacts at the central shaft through hole 948 and ballscrew shaft through holes 950.

### VIII. Movable Heave Plate

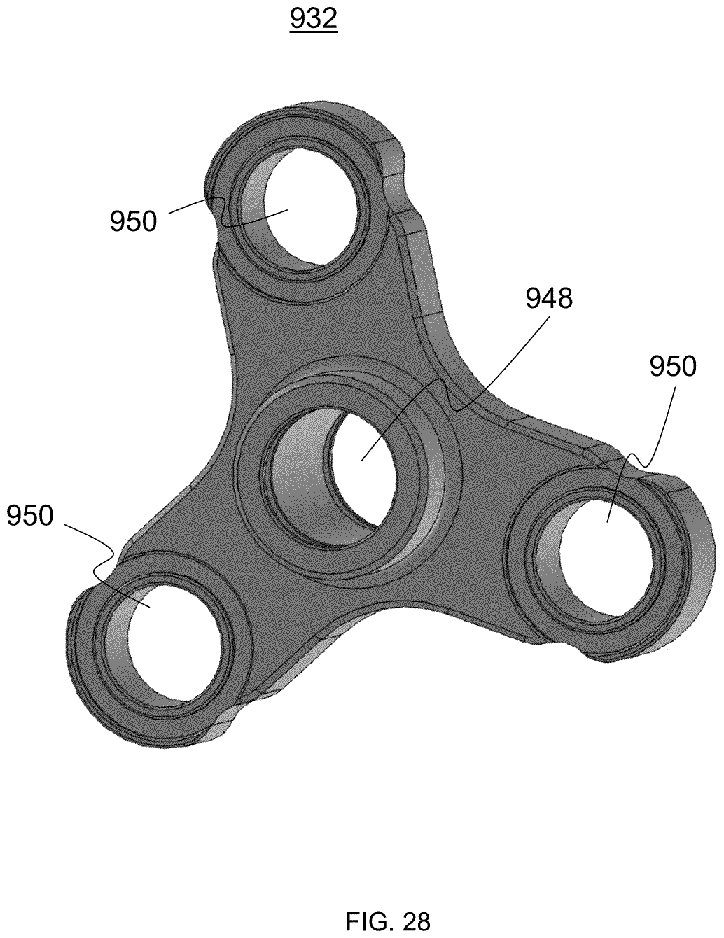

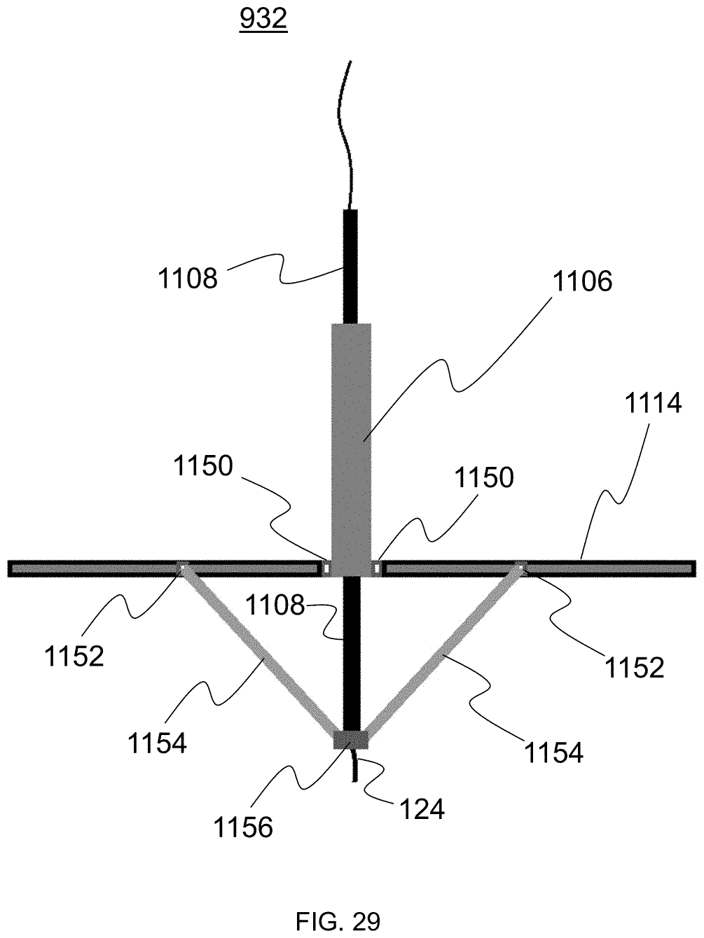

In one embodiment, it may be advantageous to utilize a movable heave plate to improve the movement, deployment and portability of the device. FIG. 29 is a side view illustration of a moveable heave plate 1114 disposed laterally from the core section 1106, similar to the embodiment illustrated in FIG. 1. However, the moveable heave plate 1114 is attached with the core section 1106 via a first pivot point 1150 which allows the heave plate 1114 to pivot in at least one direction from a substantially perpendicular angle relative to the core section 1114 to a substantially parallel angle relative to the core section 1114, as is more clearly illustrated in FIG. 30A-30C, below. The heave plate 1114 also pivots about a 2^{nd} pivot point 1152, which allows the heave plate to move in an arc created by a pivot arm 1154 connecting the 2^{nd} pivot point 1152 to the shaft 1108 at a 3^{rd} pivot point 1156. The 3^{rd} pivot point may be positioned just above the lower end of the shaft 1108 immediately adjacent to the lower cable 124 connected to a weight (not shown).

FIGS. 30A-30C are side view illustrations of the movable heave plate in different movable positions, showing only one half of the heave plate for ease of understanding. FIG. 30A illustrates a standard position, FIG. 30B illustrates an upper folded position, and FIG. 30 C illustrates a lower folded position. As the main shaft 1108 is pulled up or pushed down by a solid connection to a moving object (weight or float), the water will push on the heave plate 1114 in the opposite direction causing it to move either up or down. The configuration of heave plate 1114 to core 1106 will in turn cause the core 1106 to move in the same direction of the primary force. The heave plate 1114 will thus move away from the primary force ending in an almost parallel position to 1106. This will have effect of a lower reactionary force created as the movement begins, with the heave plate 1114 in a more parallel alignment to the core 1106, as shown in FIG. 30B. As the movement continues and the heave plate 1114 moves back to a perpendicular angle to the core 1106, the reactionary force is at its greatest. As the movement continues in the same direction, the heave plate 1114 moves back to a more parallel alignment to the core 1106 (just facing the other way, as in FIG. 30C) and again the reactionary force is reduced.

The movable heave plate is advantageous in that it defines the maximum movement of the core over the main shaft. There is no need for bumpers or stops to absorb large movements beyond the maximum stroke of the device. One of the main problems with wave energy converter (WEC) designs today is that they have to be built very large and strong to handle the power delivered by storms which can be thousands of times greater than the average power of the waves in that area. However, WEC's can only convert a percentage of power from the average wave power available, making them too expensive to be practical. The movable heave plate configuration solves this issue. Additionally, the moveable heave plate allows for easy deployment of the device into a body of water, as it can simply be thrown overboard and will quickly sink with the heave plates folded up until it reaches it maximum depth, after which it will automatically begin functioning normally as it starts reciprocating motion in the water.

In one embodiment, the device can be sized to absorb only the average energy in an area. The configuration allows for large storm waves to simply pull and push the device in a similar way to smaller waves. Once the heave plate has been moved to its maximum movable position—parallel to the core—there is very little force being applied to the device. The whole device simply moves up through the water column with the wave without absorbing any additional energy. It is this protective design that overcomes the need to build a large (and expensive) version to survive.

As stated, there are many ways to move the device, but other examples of how to design it in water might be to have the object to which the device is connected be stationary and the water move about it, e.g. the leg of a pier. Another option would be where the object could be connected with a flexible connection to the device and then the device itself be weighted or made buoyant.

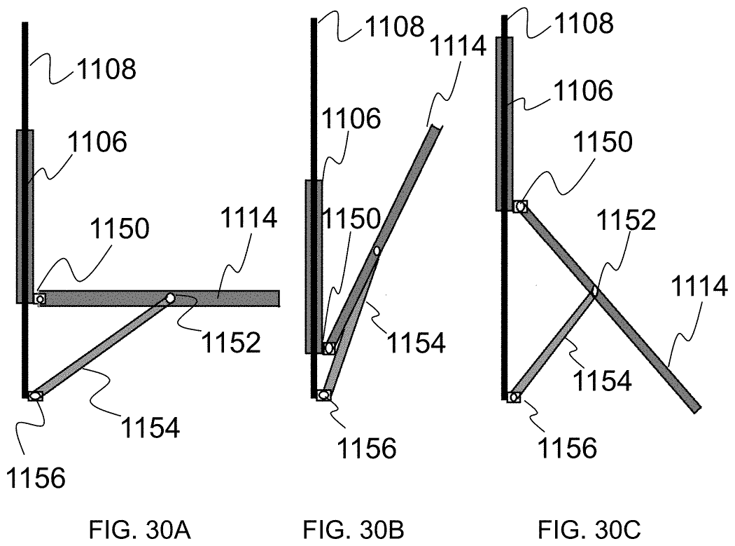

FIG. 31 is a side view illustration of a foldable heave plate in a folded configuration, according to one embodiment of the invention. The heave plate 1114 is configured with a set of hinged joints 1158 to allow for folding of the heave plate during transport or non-use. The illustration shows an outer section of the heave plate 1114 folded at an approximately 90 degree angle, although the heave plate may be folded in additional configurations as may be appropriate.

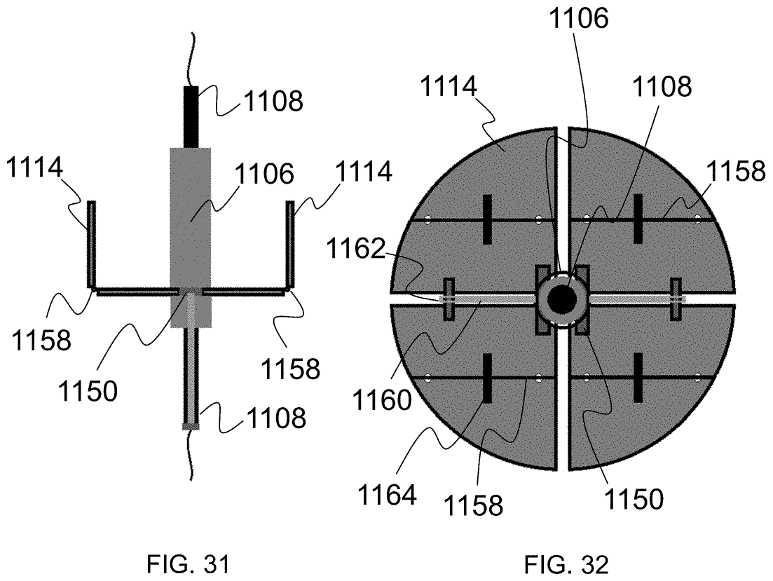

FIG. 32 is a top-down view illustration of the foldable heave plate in an unfolded configuration, according to one embodiment of the invention. In this configuration, the heave plate is separated into quadrants, where two quadrants are connected with a pivot arm 1160 via a pivot connector 1162, and where the pivot arm 1160 is then connected with the shaft at the 1^{st} pivot point 1150. The hinge 1158 of the heave plate 1114 is more clearly shown disposed across a section of the heave plate 1114, where the sections may be secured by a lock 1160.

Finally, it should also be noted that the heave plate itself may be configured with veins or other texture in order to create additional friction between the external fluid or air environment.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited

What is claimed is:

1. An elongate energy conversion device, comprising:
a core section with a central shaft movably disposed therethrough;
at least one ballscrew disposed around a threaded shaft which is parallel to the central shaft, the ballscrew retained within a central housing such that it is in movable connection with the central shaft; and
a generator disposed on at least one end of the threaded shaft, wherein vertical movement of the central shaft and central housing creates rotational movement of the threaded shaft which is converted by the generator into electrical energy.

2. The elongate energy conversion device of claim 1, wherein the core section is a sealed, fluid-filled compartment.

3. The elongate energy conversion device of claim 2, wherein the generator is disposed within a generator compartment which is separate from the core section compartment.

4. The elongate energy conversion device of claim 1, further comprising a float attached with a top portion of the central shaft.

5. The elongate energy conversion device of claim 1, further comprising a weight attached with a bottom portion of the central shaft.

6. The elongate energy conversion device of claim 1, further comprising at least one linear guide shaft disposed parallel to the threaded shafts and enclosed within the central housing to stabilize the movement of the central housing within the core section.

7. The elongate energy conversion device of claim 1, further comprising at least one heave plate disposed perpendicular to the longitudinal axis of the core section.

8. The elongate energy conversion device of claim 7, wherein the heave plate pivots relative to the core section.

9. A method of converting wave energy into electrical energy, comprising the steps of:
actuating a central shaft within a core section, the central shaft in movable connection with a central housing comprising at least one ballscrew disposed around a threaded shaft which is parallel to the central shaft;
rotating the threaded shaft in response to the actuation of the central housing; and
converting the rotation of the threaded shaft into electrical energy via a generator disposed on at least one end of the threaded shaft.

10. The method of claim 8, wherein the core section is a sealed, fluid-filled compartment.

11. The method of claim 9, wherein the generator is disposed within a generator compartment which is separate from the core section compartment.

12. The method of claim 8, further comprising actuating the central shaft via a float attached with a top portion of the central shaft.

13. The method of claim 8, further comprising actuating the central shaft via a weight attached with a bottom portion of the central shaft.

14. The method of claim 8, further comprising stabilizing the central housing by disposing at least one linear guide shaft parallel to the threaded shafts and enclosed within the central housing.

15. The method of claim 8, further comprising disposing at least one heave plate perpendicular to the longitudinal axis of the core section to increase the resistance of the core section in a body of water with respect to the movement of the central shaft.

16. An elongate energy conversion device, comprising:
a core section with a central shaft movably disposed therethrough, the core section having a pivoting heave plate disposed laterally therefrom; and
a generator disposed within the core section to convert linear motion of the central shaft into electrical energy.
